(19) United States
(12) Patent Application Publication
(10) Pub. No.: US 2010/0314848 A1
(43) Pub. Date: Dec. 16, 2010

(54) ADVERTISING TROLLEY ARRANGEMENT

(76) Inventor: James Edward Honiball, Highway Gardens (ZA)

Correspondence Address: NIXON PEABODY, LLP, 401 9TH STREET, NW, SUITE 900, WASHINGTON, DC, 20004-2128, US

(21) Appl. No.: 12/863,274

(22) PCT Filed: Dec. 24, 2008
(86) PCT No.: PCT/IB2008/003615

§ 371 Date: Jul. 16, 2010

(30) Foreign Application Priority Data
Jan. 16, 2008 (ZA) 2008/00467

(51) Int. Cl. B62D 39/00; G09F 15/00

(52) U.S. Cl. 280/33.992; 40/606.03

(57) ABSTRACT

An advertising trolley arrangement (10) is disclosed comprising a trolley (12) having at least one basket defined by at least a pair of side walls (16,18) and a front end wall. At least one of the side walls or front end wall comprises at least one frame border (22, 24 . . . 38) for defining at least one frame holder (22.1,24.1 . . . 38.1) At least one' of the side walls or front end wall comprising a plurality of parallel, spaced apart wire strands (40). The arrangement further comprises an advertising board (42) located within one of the frame holders and at least one securing clip (44) for securing the advertising board to a wire strand. The securing clip comprises a base portion defining an elongate slot for accommodating the wire strand, with the advertising board being securable to the base portion so as to sandwich the wire strand between the securing clip and the advertising board, thereby securing the advertising board to the wire strand.

### FIELD OF THE INVENTION

This invention relates to an advertising trolley arrangement.

### BACKGROUND OF THE INVENTION

The idea of advertising on trolleys is not new. However, most existing advertising arrangements for trolleys are relative complicated, requiring a number of components and/or modifications to accommodate a board carrying the relevant advertising. In particular, trolleys typically have a back gate that can flip upwardly to accommodate another trolley, with existing advertising arrangements not being designed to facilitate this stacking of trolleys.

### OBJECT OF THE INVENTION

It is an object of this invention to provide an advertising trolley arrangement that is simple and convenient to implement, that can easily be retrofitted to existing trolleys, and that enables trolleys to accommodate other trolleys.

### SUMMARY OF THE INVENTION

In accordance with a first aspect of this invention there is provided an advertising trolley arrangement comprising:
a trolley comprising at least one basket defined by at least a pair of side walls and a front end wall, at least one of the side walls or front end wall comprising at least one frame border for defining at least one frame holder, with at least one of the side walls or front end wall comprising a plurality of parallel, spaced apart wire strands;
an advertising board located within one of the frame holders; and
at least one securing clip for securing the advertising board to a wire strand, the securing clip comprising a base portion defining an elongate slot for accommodating the wire strand, with the advertising board being securable to the base portion so as to sandwich the wire strand between the securing clip and the advertising board, thereby securing the advertising board to the wire strand.

In an example embodiment, the trolley comprises a back gate that can be pivoted upwardly so as to receive a second trolley, the securing clip being sized and shaped so as to not hinder this stacking feature of the trolleys.

In an example embodiment, the securing clip comprises a top face defining at least one bevelled surface so as to guide the second trolley into position within the trolley fitted with the advertising board and securing clip.

In an example embodiment, the advertising board is sized and shaped so as to be substantially surrounded by the at least one frame border.

In an example embodiment, the advertising board is glued to the base portion of the securing clip.

Alternatively, the advertising board is removably secured to the securing clip.

In an example embodiment, the frame border comprises a wire frame.

In an example embodiment, one, two or three frame borders are provided in one of the side walls and/or the front end wall.

In an example embodiment, the advertising board within the frame holder takes up substantially the entire area defined by the frame holder, or at least 90% of the frame holder's area.

In accordance with a second aspect of this invention there is provided an advertising kit for a trolley comprising at least one basket defined by at least a pair of side walls and a front end wall, at least one of the side walls or front end wall comprising at least one frame border for defining at least one frame holder, with at least one of the side walls or front end wall comprising a plurality of parallel, spaced apart wire strands, the advertising kit comprising:
an advertising board carrying advertising material for insertion into one of the frame holders; and
at least one securing clip for securing the advertising board to a wire strand, the securing clip comprising a base portion defining an elongate slot for accommodating the wire strand, with the advertising board being securable to the base portion so as to sandwich the wire strand between the securing clip and the advertising board.

In accordance with a third aspect of this invention there is provided a securing clip for securing an advertising board to a trolley, the trolley comprising at least one basket defined by at least a pair of side walls and a front end wall, at least one of the side walls or front end wall comprising at least one frame border for defining at least one frame holder for accommodating the advertising board, with at least one of the side walls or front end wall comprising a plurality of parallel, spaced apart wire strands, the securing clip comprising a base portion defining an elongate slot for accommodating the wire strand, with the advertising board being securable to the base portion so as to sandwich the wire strand between the securing clip and the advertising board.

### BRIEF DESCRIPTION OF THE DRAWINGS

FIG. 1 shows a perspective view of an advertising trolley arrangement, according to an example embodiment;

FIG. 2 shows a cross-sectional side view of a portion of the advertising trolley arrangement shown in FIG. 1;

FIG. 3 shows a perspective view of a securing clip used in the advertising trolley arrangement shown in FIG. 1; and

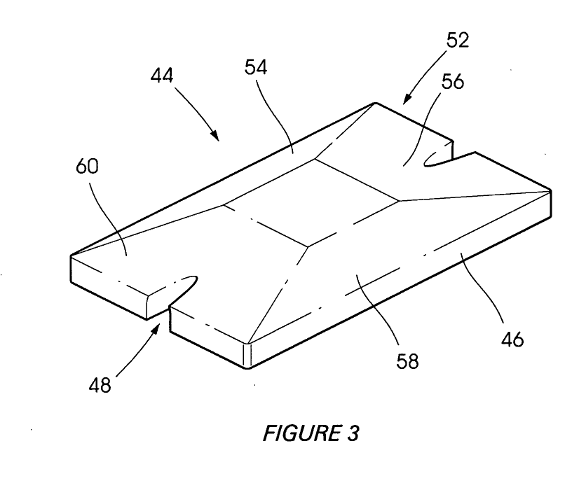

FIGS. 4 to 7 show top, bottom, side and end views, respectively, of the securing clip shown in FIG. 3.

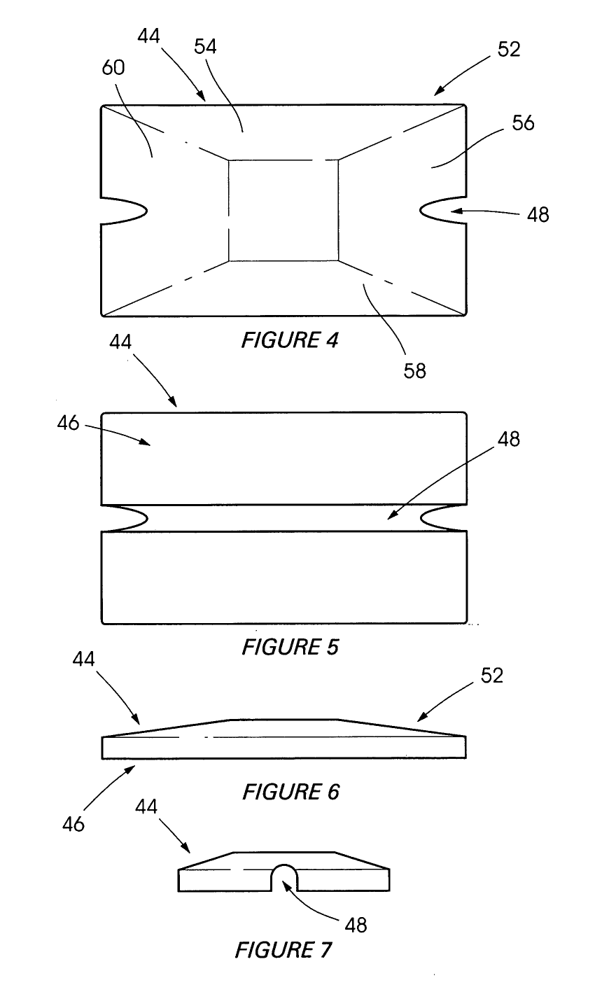

### DESCRIPTION OF PREFERRED EMBODIMENTS

Referring to the figures, an advertising trolley arrangement 10 comprises a trolley 12 comprising a basket 14 defined by at least a pair of side walls 16, 18 and a front end wall 20. Although the invention is described with reference to a trolley with a single basket, it should be clear that it may be used on trolleys with multiple baskets.

At least one of the side walls 16, 18 or front end wall 20 comprises at least one frame border for defining an associated frame holder. Thus, in the illustrated embodiment, side wall 16 comprises 3 frame borders 22, 24 and 26, side wall 18 comprises 3 frame borders 28, 30 and 32, and front end wall 20 comprises 3 frame borders 34, 36 and 38. According, each of these frame borders 22, 24, 26, 28, 30, 32, 34, 36 and 38 define frame holders 22.1, 24.1, 26.1, 28.1, 30.1, 32.1, 34.1, 36.1 and 38.1.

In an example embodiment, the trolley 12 is a conventional wire trolley, with the basket 14 being fitted, at its bottom, to a wheeled carriage 22, and, at its top, with a handle 24 for allowing a user to push the trolley 12. In particular, at least one of the side walls 16, 18 or front end wall 20 comprises a plurality of parallel, spaced apart wire strands 40. In addition, each of the frame borders 22 to 38 also typically comprises a wire frame.

The advertising trolley arrangement 10 comprises an advertising board 42 located within one of the frame holders 22.1 to 38.1, the advertising board 42 typically carrying pre-printed advertising material. In an example embodiment, as illustrated, the advertising board 42 is sized and shaped so as to be substantially surrounded by the relevant frame border 22 to 38. In the illustrated embodiment, the advertising board 42 is thus snugly accommodated within the frame holders 22.1 and 28.1. Thus, as indicated above, in an example embodiment, the advertising board 42 within each frame holder 22.1 to 38.1 takes up substantially the entire area defined by the frame holder, or at least 90% of the frame holder's area.

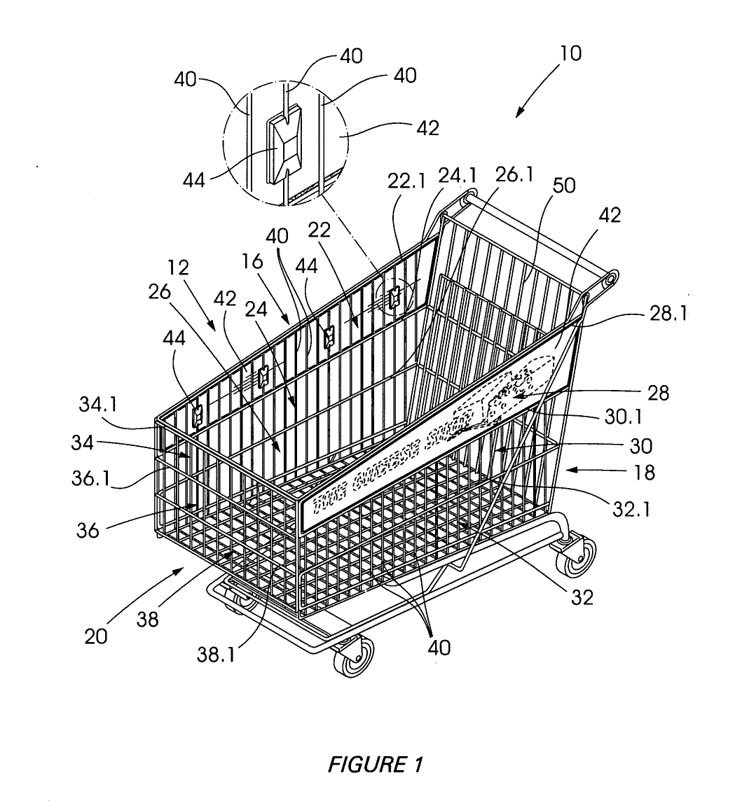

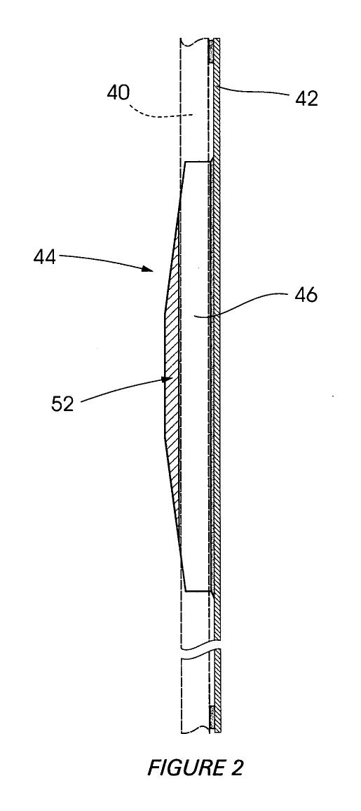

The advertising trolley arrangement 10 further comprises at least one securing clip 44 for securing the advertising board 42 to a wire strand 40. The securing clip 44 comprises a base portion 46 defining an elongate slot 48 for accommodating the wire strand 40. As best shown in FIGS. 1 and 2, the advertising board 42 is securable to the base portion 46 so as to sandwich the wire strand 40 between the securing clip 44 and the advertising board 42, thereby securing the advertising board 42 to the wire strand 40.

In an example embodiment, the trolley 12 comprises a back gate 50 that can be pivoted upwardly so as to receive a second trolley, as is well known in the art. The securing clip 44 is specifically sized and shaped so as to not hinder this stacking feature of the trolleys 12. In particular, the securing clip 44 comprises a top face 52 defining at least one bevelled surface, but typically 4 bevelled surfaces 54, 56, 58 and 60, so as to guide the second trolley into position within the trolley 12 fitted with the advertising board 42 and securing clip 44.

In an example embodiment, the advertising board 42 is glued to the base portion 46 of the securing clip 44. Alternatively, the advertising board 42 may be removably secured to the securing clip 44.

This invention thus provides an advertising trolley arrangement that is simple and convenient to implement, and that can easily be retrofitted to existing trolleys.

1. An advertising trolley arrangement comprising:
a trolley comprising at least one basket defined by at least a pair of side walls and a front end wall, at least one of the side walls or front end wall comprising at least one frame border for defining at least one frame holder, with at least one of the side walls or front end wall comprising a plurality of parallel, spaced apart wire strands;
an advertising board located within one of the frame holders; and
at least one securing clip for securing the advertising board to a wire strand, the securing clip comprising a base portion defining an elongate slot for accommodating the wire strand, with the advertising board being securable to the base portion so as to sandwich the wire strand between the securing clip and the advertising board, thereby securing the advertising board to the wire strand.

2. The advertising trolley arrangement of claim 1, wherein the trolley comprises a back gate that can be pivoted upwardly so as to receive a second trolley, the securing clip being sized and shaped so as to not hinder this stacking feature of the trolleys.

3. The advertising trolley arrangement of claim 2, wherein the securing clip comprises a top face defining at least one beveled surface so as to guide the second trolley into position within the trolley fitted with the advertising board and securing clip.

4. The advertising trolley arrangement of claim 1, wherein the advertising board is sized and shaped so as to be substantially surrounded by the at least one frame border.

5. The advertising trolley arrangement of claim 1, wherein the advertising board is glued to the base portion of the securing clip.

6. The advertising trolley arrangement of claim 1, wherein the advertising board is removably secured to the securing clip.

7. The advertising trolley arrangement of claim 1, wherein the frame border comprises a wire frame.

8. The advertising trolley arrangement of claim 1, wherein one, two or three frame borders are provided in one of the side walls and/or the front end wall.

9. The advertising trolley arrangement of claim 1, wherein the advertising board within the frame holder takes up substantially the entire area defined by the frame holder, or at least 90% of the frame holder's area.

10. An advertising kit for a trolley comprising at least one basket defined by at least a pair of side walls and a front end wall, at least one of the side walls or front end wall comprising at least one frame border for defining at least one frame holder, with at least one of the side walls or front end wall comprising a plurality of parallel, spaced apart wire strands, the advertising kit comprising:
an advertising board carrying advertising material for insertion into one of the frame holders; and
at least one securing clip for securing the advertising board to a wire strand, the securing clip comprising a base portion defining an elongate slot for accommodating the wire strand, with the advertising board being securable to the base portion so as to sandwich the wire strand between the securing clip and the advertising board.

11. The advertising kit of claim 10, wherein the trolley comprises a back gate that can be pivoted upwardly so as to receive a second trolley, the securing clip being sized and shaped so as to not hinder this stacking feature of the trolleys.

12. The advertising kit of claim 11, wherein the securing clip comprises a top face defining at lest one beveled surface so as to guide the second trolley into position within the trolley fitted with the advertising board and securing clip.

13. The advertising kit of claim 10, wherein the advertising board is sized and shaped so as to be substantially surrounded by the at least one frame border.

14. The advertising kit of claim 10, wherein the advertising board can be glued to the base portion of the securing clip.

15. A securing clip for securing an advertising board to a trolley, the trolley comprising at least one basket defined by at least a pair of side walls and a front end wall, at least one of the side walls or front end wall comprising at least one frame border for defining at least one frame holder for accommodating the advertising board, with at least one of the side walls or front end wall comprising a plurality of parallel, spaced apart wire strands, the securing clip comprising a base portion defining an elongate slot for accommodating the wire strand, with the advertising board being securable to the base portion so as to sandwich the wire strand between the securing clip and the advertising board.

16. The securing clip of claim 15, which comprises a top face defining at least one beveled surface.

17. (canceled)
